(19) United States
(12) Patent Application Publication
(10) Pub. No.: US 2025/0263285 A1
(43) Pub. Date: Aug. 21, 2025

(54) Oak Variable Capacity Tank Lid

(71) Applicant: Kelli Daniella Brown, Sonoma, CA (US)

(72) Inventor: Kelli Daniella Brown, Sonoma, CA (US)

(21) Appl. No.: 18/443,364

(22) Filed: Feb. 16, 2024

(51) Int. Cl. B67D 1/08

(52) U.S. Cl. CPC B67D 1/0807

(57) ABSTRACT

The invention is a variable capacity oak lid that can be custom fitted to existing stainless-steel, concrete, or other material tanks, and fitted with an exterior air bladder gasket which allows the lid to float on top of the liquid to prevent airspace, fitted with an airlock to allow gas to escape, and to be pressurized so that no air can get in. While similar stainless lids exist in the marketplace, there are no similar oak lids yet available, nor has there been a previous patent application for a tank lid strategically constructed in this manner.

### FIELD OF THE INVENTION

The invention relates to a variable capacity tank lid, that is constructed from oak, with a stainless-steel rim, an airlock and surrounding air bladder gasket with attached pump.

### BACKGROUND OF THE INVENTION

Wine making is both an art and a science, that is driven by hundreds of years of traditional practice. Given that the winemaker only has one time per year to make any given lot, and that mistakes can be costly, historical practice is widely followed. The oak barrel has been the traditional way of aging wine that has both advantages and disadvantages, discussed below. Modern practice has been to ferment and age wine in stainless-steel tanks as well, which also has its pros and cons. This invention of an oak variable capacity tank lid combines the many benefits of both vessels in a way that creates multiple advantages.

### OBJECT AND SUMMARY OF THE INVENTION

Traditional wine barrels can impart many benefits to the wine. On the positive side, the porous nature of the barrel allows water and ethanol to evaporate, producing a more concentrated and flavorful wine. The oak itself imparts delicate flavors including vanilla, sweet spice, toast, and coconut that can beneficially enhance the wine. The micro-oxygenation from the porous barrels binds to the tannins, creating a smoother and more pleasant profile to the wine.

The negative side of using barrels are multiple. They can be very expensive, with new barrels costing between $900 and $2,000. In addition, oak trees are a limited resource, taking between 80-90 years of growth before American oak can be harvested for barrels and anywhere from 150 to 200 years for French and other European oak. The fact that they are porous allows for evaporation of as much as a quart to a gallon of wine per month from a standard 60-gallon barrel (about 14% of their volume over three years). This in turn exposes the wine to oxygen, which is the beginning of the chemical pathway to vinegar. Preventing this exposure to excess oxygen requires the winemaker to frequently open the bung to top up the barrels with additional wine, which could further expose the wine to unwanted oxygen, bacteria and other unwanted microbes, potentially inferior wine used for topping, or human error in using the incorrect topping wine. In addition, the topping of each barrel adds significantly to labor time and expense. After two to three years, the barrels no longer impart any oak flavors, forcing winemakers to replace them or use them as “neutral” barrels for wines that won't get any oak flavor. Barrels cannot be temperature controlled unless they are placed in a cold storage room with a desired constant temperature. Finally, the interior of the oak barrels can only be accessed through a small bung hole, making the cleaning of the barrels difficult and water intensive with specialized hot water and steam cleaners.

Stainless steel wine tanks were introduced in the 1950's which solved may of the problems encountered with barrels. Their stainless-steel surface can be better sanitized, thus producing cleaner wines without off-aromas of common wine spoilage microbes. In addition, many modern tanks have built-in temperature control, an important element to winemaking, allowing them to be placed in a wider range of locations. Their non-porous nature prevents evaporation and eliminates the need to top up tanks and can prevent damaging exposure to oxygen.

The negative aspects of stainless steel are precisely what's lost by not having the benefit of oak, including subtle flavor, concentration through evaporation, and micro-oxygenation to smooth tannins.

The object of the present invention of the variable capacity oak lid is to provide oak flavors, provide for evaporation and concentration, reduce cost, increase sustainability, prevent excessive oxidation, allow for micro-oxygenation, allow for renewal, cleaning, and sanitation, allow for temperature control on a tank-by-tank basis, and allow for sampling without risk of contamination and oxidation.

The current invention can be custom fitted and used interchangeably with a winery's existing variable capacity tanks, thus reducing winery cost, and making the most of limited wine tank space. With traditional barrels, to control the temperature of the contents, the entire cellar would need to be chilled. However, with the current invention, you would have the advantage of the temperature controlled stainless tank in combination with the oak contact of the lid, to give both the oak flavors as well as the concentration and integration provided by the allowance for evaporation and micro-oxygenation.

In addition, it creates efficiencies in the winery by being able to use an existing wine tank in three different ways: First, with a traditional stainless lid for un-oaked whites; second, an oaked lid for reds; and finally, an oaked lid for white wines. Traditional barrels do not have the flexibility of being used for red wine and then for white, because the stained barrels from the red wine would impart a pink color to white wines following.

### DESCRIPTION OF THE PRIOR ART

As noted above, the current invention serves several advantageous purposes, and prior art has dealt with the individual components of those, which will be discussed below. However, it is only the current invention that can provide all the advantages together.

Preventing Oxidation. Excessive exposure of wine to oxygen can irrevocably damage the wine impacting its taste, color, and aroma profile. U.S. Pat. No. 5,976,583 issued to Edward P. Mastrocola on 2 Nov. 1999 discusses the importance of preventing oxidation caused by exposure to oxygen in wine. Mastrocola notes that: “Prevention of oxidation and spoilage, which results from prolonged air contact, are of prime concern during the wine-aging process.” This prior art sought to automatically maintain fill levels in barrels with a gravity fed system of topping wine from an external source. Similarly, prior art Witoski (WO2007124919A1) sought to prevent oxidation with an external storage device connected to the barrel.

The disadvantage of these methods is that you are still using oak barrels, that are expensive, cannot be individually temperature controlled, are difficult to clean and can only impart their oak flavors for up to three years, thus not being environmentally sustainable. The present invention avoids oxidative damage by allowing the top to drop to liquid level quickly and easily to safely maintain an anaerobic environment.

Concentration of Wine. One of the reasons oak barrels are used to age wine, is that the wine becomes concentrated and more intensely flavored due to the partial evaporation of water and ethanol. The invention in U.S. Pat. No. 11,345,505 issued to Mark Joseph McKale on 31 May 2022 discusses the fact that a significant portion of the liquid may be lost due to evaporation. These losses may be as high as 10% in the first year and may be approximately 3% in subsequent years. This prior art discloses a gas tight environment between the barrel and the barrel cap to seek to eliminate this evaporative loss.

Similarly, U.S. Pat. No. 5,174,461 issued to Stephen T. Sullivan on 29 Dec. 1992 proposes to eliminate the entirety of the ullage as well by disclosing a stainless, non-porous barrel with oak staves in the interior. U.S. Pat. No. 9,944,891 issued to Seetharaman Chidambarakrishnan et al. on 17 Apr. 2018 discloses a similar invention by using non-porous materials. The disadvantages of these inventions are that they seek to eliminate this evaporation altogether, thus ignoring the benefits of the wine concentration that it can achieve.

With the present invention, the variable capacity lid would be periodically dropped so that no airspace or foreign “topping” wine would need to be introduced to replace the wine lost due to evaporation. And yet the oak lid would allow for some evaporation to occur to obtain the favorable concentration. This impact can be adjusted by the winemaker with changes in ambient humidity as well as choice of tank and ratio of wine volume to oak contact.

Avoid expensive and wine changing top ups. As noted above, with traditional barrels, the loss of liquid introduces oxygen that may excessively oxidize and harm the wine. Therefore, there is a tradition of “topping up” or refilling these barrels. This carries the risk of introducing tainted or lesser quality wine, or the risk of the cellar staff missing a top-up and allowing damage through oxidation and/or spoilage organisms into the wine. U.S. Pat. No. 8,365,758 issued to Mark. A. Maiocco on 2 May 2013 provides a good description of the disadvantages of the topping practice: “In an attempt to control ullage, wineries devote large sums of money to create and operate elaborate humidification systems, and for the labor required to consistently “top-up” the barrels, to minimize headspace. Additionally, the “top-up” wine is often inferior quality, newer wine, which detracts from the flavor of the aged wine within the barrel. However, even the most diligent topping-up fails to eliminate ullage, and the undesirable favoring resulting from head-space oxidation.” In Maiocco's invention, traditional barrels are used in conjunction with a bladder system to remove barrel headspace. While this does solve the topping problem, it does not have the advantages of the current invention of better temperature control, sustainability, and easier barrel sanitation, as discussed below.

Oak Contact Flavor. The importance of desired oak flavoring in wine making are discussed at length in U.S. Pat. No. 7,240,609 issued to Imre Berecz on 10 Jul. 2007. Berecz recognizes the flavors provided by oak, but also points out the disadvantages of oak infusion inventions that do not allow for micro-oxygenation to aid in the aging process. The disadvantage of Berecz's system is the continued need to top up the wine barrel and the risk of excessive oxygen exposure as discussed above. With the current invention, oak contact can be controlled by the winemaker by choosing the tank size and fill levels to select the desired liquid to oak contact ratios.

Micro-ox to smooth tannins. A small amount of oxygen in the wine aging process is important to bind with tannins and smooth out the wine's mouthfeel. The porous nature of oak allows the wine to breathe and slow oxidation to occur when the headspace is properly managed in traditional barrels. U.S. Pat. No. 7,722,908 issued to Anthony Earl Flecknow-Brown and Michal James Unwin on 25 May 2010 describes this micro-oxygenation as developing a desired aged wine bouquet and character by “controlled and slow oxidation of various wine substances especially the phenolic compounds. This slow oxidation, followed by polymerization, results from limited and gradual exposure to air oxygen diffusing through the walls of the barrel over months.” This prior art discloses a container with a very small amount of oxygen permeability that allows enough for micro-oxygenation but does not have the economic advantage of the current invention of being fitted to existing temperature-controlled tanks.

Ability to sample wine without opening barrel. In a traditional barrel, the bung needs to be opened and a wine thief is inserted to sample the wine. This can potentially introduce bacteria through improperly sanitized sampling tools as well as introduce oxygen each time the barrel bung is removed. Winemakers will often check and sample their barrels as often as weekly to assess its development. With the current invention, a small sample can be taken though the tank's sampling valve, often displacing so little that a quick adjustment of the tank's variable capacity lid seal would not be needed. No foreign objects would be inserted into the wine, and no openings created to allow for the ingress of oxygen. U.S. Pat. No. 11,866,680 issued to Elyashiv Drori on 9 Jan. 2024 tackles the problem of excess oxygen ingress with the use of traditional barrels with a system of flow between barrels and a tank, thus allowing sampling through the tank valve. The current invention would provide similar results without the additional expense and storage space.

Refurbishment and cost reduction. Depending on quality, wine barrels can cost between $500 to over $2,000 each. U.S. Pat. No. 10,640,259 issued to Andrew Deutsch and Donald P. Kish on 5 May 2020 notes that wood barrels “[ . . . ] are becoming increasingly expensive to purchase and maintain, and their high cost is at least partly due to the fact that their construction requires skilled coopers to make and repair the barrels and, moreover, often utilizes the most valuable parts of the trees.” This prior art discloses a barrel lid that is anti-warping and longer lasting, however, unlike the current invention, is not variable capacity and it still requires “topping,” therefore creating exposure and potential damage to topping risks as discussed above.

Sustainability. Quality oak is a limited resource, that will ultimately be depleted without the adoption of more sustainable practices. As noted above, oak barrels generally only impart oak flavors for two to three years. However, to make a quality barrel, U.S. Pat. No. 10,640,259 issued to Andrew Deutsch and Donald P. Kish on 5 May 2020 points out that “[ . . . ] construction of a typical 59-gallon oak wine barrel requires the consumption of two (2) full oak trees, which may be more than one hundred (100) years old.” Similarly, U.S. Pat. No. 10,968,008 issued to Gheorghe Voicu on 6 Apr. 2021 and U.S. Pat. No. 9,701,439 issued to Bruno Visentin on 11 Jul. 2017 both provide good discussions for the need of sustainability, and both disclose reusable containers with replaceable oak components. However, unlike the current invention, neither of those solve the problem of unwanted head space created by evaporation. With the current invention, the interior of the oak is accessible, and therefore can be sanded and refurbished to obtain the full oak flavor characteristics and reused many more times than a traditional barrel. This means significant less cost and less trees that need to be cut down to produce new barrels.

Better Sanitation. Traditional oak wine barrels are notoriously difficult to clean and sanitize given the fact that the only interior access is through a small bung hole. Prior art such as Visentin cited above (U.S. Pat. No. 9,701,439) with replaceable oak components allows access for sanitation of the porous wood but does not eliminate topping requirements. U.S. Pat. No. 11,484,918 issued to Ulf Thorstensson and Kyle Hocking on 1 Nov. 2022 discloses a barrel cleaner for traditional barrels and includes a good discussion of the safety and logistical issues of barrel cleaning. With the current invention, the interior of the oak lid is completely accessible once the wine has finished aging and can be both sanitized and sanded to reach a fresh, clean layer of oak surface.

### BRIEF DESCRIPTION OF DRAWINGS

The embodiments set forth in the drawings are illustrative and exemplary in nature and not intended to limit the subject matter defined by the claims. The following detailed description of the illustrative embodiments can be understood when read in conjunction with the following drawings.

FIG. 1 is a side view of an embodiment of an oak and stainless-steel variable capacity tank lid.

FIG. 2 is a top view of an embodiment of an oak and stainless-steel variable capacity tank lid.

### DETAILED DESCRIPTION OF THE DRAWINGS

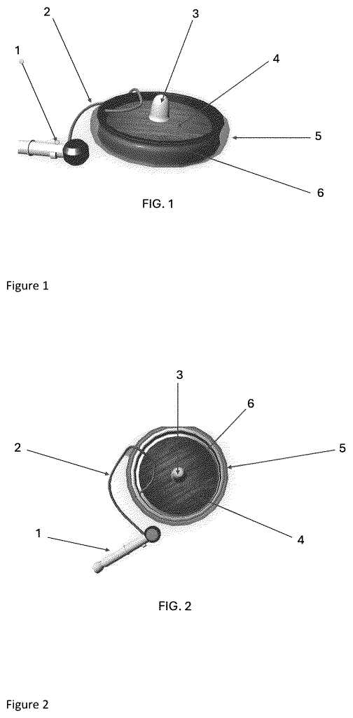

With reference to FIGS. 1-2, disclosed is a variable capacity lid constructed of oak staves (4) with a stainless-steel rim (6) to secure them in place, and fitted with an airlock (3). A gasket (5) surrounds the stainless rim that is pumped with air by use of an external pump (1) connected by an attached tube (2).

While there have been described what is presently believed to be the preferred embodiments of the invention, those skilled in the art will realize that various changes and modifications may be made to the invention without departing from the invention, and it is intended to claim all such changes and modifications that fall within the scope of the invention.

1. What is claimed is a composite oak and stainless-steel variable capacity tank lid, to which an airlock and a gasket made of appropriate liquid-resistant material is attached and connected to an air pump by tube.
